(19) United States
(12) Patent Application Publication
(10) Pub. No.: US 2015/0251477 A1
(43) Pub. Date: Sep. 10, 2015

(54) PUBLICATION AND ADVERTISING METHOD INCORPORATING FLIP PAGE ANIMATION

(71) Applicant: John N. Miller, Matthews, NC (US)

(72) Inventor: John N. Miller, Matthews, NC (US)

(21) Appl. No.: 14/721,526

(22) Filed: May 26, 2015

Related U.S. Application Data
(63) Continuation of application No. 12/075,866, filed on Mar. 14, 2008, now abandoned.
(60) Provisional application No. 60/065,737, filed on Nov. 17, 1997.

(51) Int. Cl. B42D 1/00

(52) U.S. Cl. CPC B42D 1/009

(57) ABSTRACT

A publication includes a bound arrangement of overlying paper pages. A series of pictorial representations is provided on successive ones of the pages. Succeeding pages represent an object in different progressive positions, such that flipping the pages in rapid succession conveys a visual impression of the object in motion. A display of advertising is provided on a reference page of the publication, and includes information relating to the object. A reference page identifier is located proximate the object, and directs a user of the publication to the display of advertising provided on the reference page.

### TECHNICAL FIELD AND BACKGROUND

The present disclosure relates broadly and generally to a publication and advertising method incorporating flip page animation. The basic concept of “flip page” animation dates back more than 100 years to prior patents, U.S. Pat. Nos. 258,164 and 259,950 issued to Van Hoevenbergh. Van Hoevenberg's “flip book” incorporates a series of pictures that vary gradually from one page to the next, so that when the pages are turned rapidly, the pictures appear to animate by simulating motion or some other change. The concept relies on persistence of vision to create the illusion that continuous motion is being seen rather than a series of discontinuous images being exchanged in succession. Rather than “reading” left to right, a viewer simply stares at the same location of the pictures in the flip book as the pages turn. The book must also be flipped with sufficient speed for the illusion to work.

Exemplary embodiments of the present invention combine the concept of flip page animation in a marketing tool, such as a paper catalog publication. For marketing purposes, traditional flip page animation by itself is of limited value given the relatively brief display of simulated motion. This holds particularly true in relatively large publications containing many advertisements by several different companies.

### SUMMARY OF EXEMPLARY EMBODIMENTS

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

According to one exemplary embodiment, the invention may comprise a publication including a bound arrangement of overlying paper pages. A series of pictorial representations is provided on successive ones of the pages. Succeeding pages represent an object in different progressive positions, such that flipping the pages in rapid succession conveys a visual impression of the object in motion. An advertising display (or display of advertising) is provided on a reference page of the publication, and comprises information relating to the object. A reference page identifier is located proximate the object, and directs a user of the publication to the advertising display provided on the reference page.

The term “pictorial” means pertaining to, expressed in, or of the nature of hand-drawn sketches, computer-generated drawings, images, shapes, photographs, video frames, or the like.

The term “advertising display” includes, but is not limited to, any graphic, shape, sketch, logo, design, word, phrases, descriptions, pricing information, payment term, payment options, pictures, photographs, and any combination thereof.

The term “reference page identifier” means any words or indicia intended to refer a user to a particular page or location of a publication. For example, the following are all considered reference page identifiers: “See Ad on Page 55”; “See Inside Cover”; “See Outside Cover”; “See Inside”; “p. 55”; and “55”.

The phrase “proximate the object” means near the object in either actual location or in time. For example, a reference page identifier printed directly beneath an object on a page of the publication is considered proximate the object. Likewise, a reference page identifier that would be viewable by a user immediately prior to flipping the pages of the publication to convey the visual impression of the object in motion is also considered proximate the object.

The term “succession” and “succeeding” means occurring one after the other in sequence, but does not require than succeeding pages or pages in succession necessarily be immediately adjacent one another (i.e., as in pages 21 and 22).

According to another exemplary embodiment, the reference page identifier comprises a page number located on each of the pages representing the object in different progressive positions.

According to another exemplary embodiment, the pages are substantially superimposed and bound together adjacent a common margin.

According to another exemplary embodiment, the pictorial representations are located in respective margins of the pages.

According to another exemplary embodiment, the pictorial representations are located in respective corners of the pages.

According to another exemplary embodiment, each pictorial representation occupies less than 10% of a surface area defined by a single side of the page.

According to another exemplary embodiment, the publication includes at least 50 bound and overlying paper pages.

According to another exemplary embodiment, the pictorial representations appear on at least 50% of a total number of pages included in the publication.

According to another exemplary embodiment, the pictorial representations appear on greater than 75% of a total number of pages included in the publication.

According to another exemplary embodiment, the advertising display provided on the reference page comprises a display object of a type depicted in the pictorial representations.

According to another exemplary embodiment, the advertising display provided on the reference page further comprises pricing information for the display object.

In yet another exemplary embodiment, the publication includes a bound arrangement of overlying paper pages. Each page has a margin adjacent an unattached edge. A series of pictorial representations is provided in the margins of successive ones of the pages. Succeeding pages represent an object in different progressive positions and at different locations in respective margins, such that flipping the pages in rapid succession conveys a visual impression of the object moving from one end of the page margins towards an opposite end of the page margins. A display of advertising is provided on a reference page of the publication, and includes information relating to the object.

In yet another exemplary embodiment, the invention may comprise a method for advertising in a publication comprising a bound arrangement of overlying paper pages. The method includes providing a series of pictorial representations on successive pages of the publication. Succeeding pages represent an object in different progressive positions, such that flipping the pages in rapid succession conveys a visual impression of the object in motion. An advertising display related to the object is displayed on a reference page of the publication. A user of the publication is directed to the reference page to view the advertising display.

### BRIEF DESCRIPTION OF THE DRAWINGS

The description of exemplary embodiments proceeds in conjunction with the following drawings, in which:

FIG. 1 is a perspective view of a publication according to one exemplary embodiment of the present invention, and demonstrating the progressive positions of an object printed in the lower corner of successive pages;

FIG. 2 is a fragmentary view demonstrating one means of flipping the pages in rapid succession to convey a visual impression of the object in motion;

FIG. 3 is an enlarged, fragmentary view of an exemplary reference page of the publication; and

FIG. 4 is a perspective view of a publication according to a second exemplary embodiment of the present invention.

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at lease one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterite) is not intended to indicate or imply that the invention has been previously reduced to practice or that any testing has been performed.

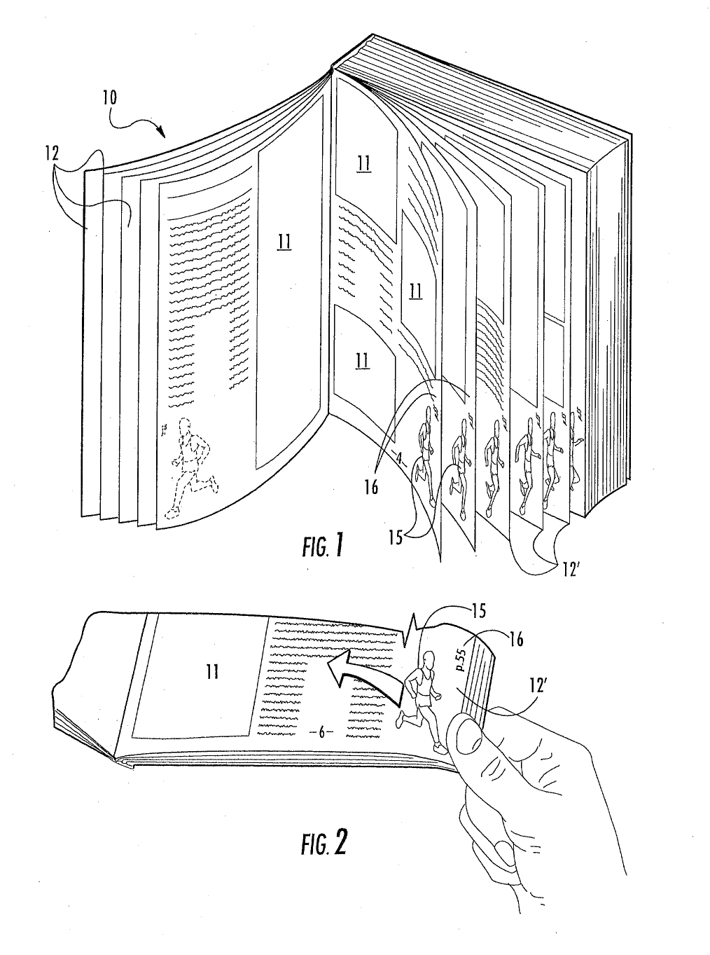

Referring now specifically to the drawings, a publication incorporating flip page animation according to one exemplary embodiment of the present invention is illustrated in FIG. 1 and shown generally at reference numeral 10. The term “animation” refers broadly and generally herein to the act, process, or result of conveying a visual impression of an object in motion (or changing appearance). In the exemplary embodiment shown, the publication 10 comprises a paper catalog containing a variety of advertising displays 11. Each display 11 may include one or more graphics, shapes, sketches, logos, designs, words, phrases, descriptions, pricing information, payment terms, payment options, pictures, photographs, and any combination thereof.

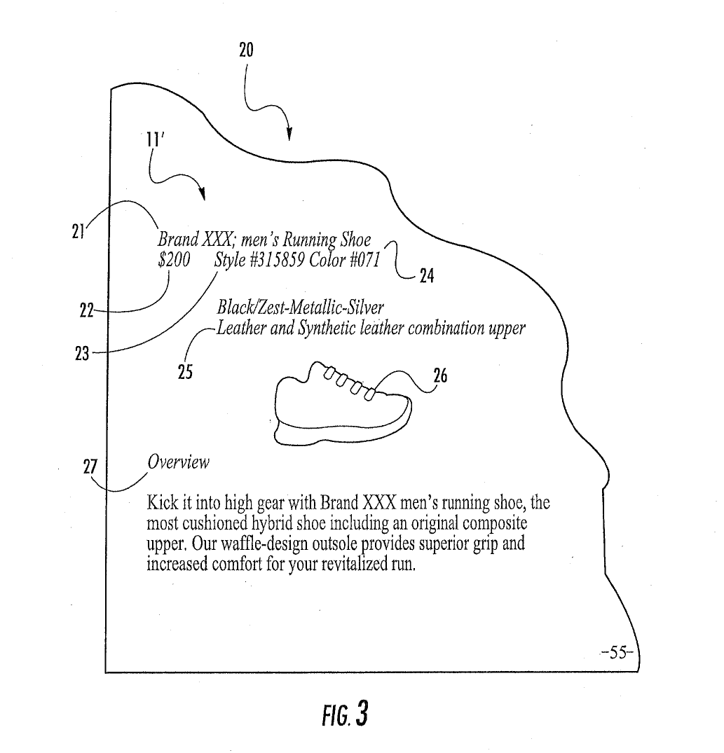

Referring to FIGS. 1, 2, and 3, the publication 10 comprises a bound arrangement of overlying, sequentially numbered, paper pages 12 including a series of pictorial representations 15 provided on certain successive pages 12′. In this exemplary embodiment, the pictorial representations 15 include a runner wearing running shoes, and represented in different progressive positions from one page 12′ to the next. The runner image 15 may comprise, for example, a series of individual “real life” video frames digitally captured and reproduced individually onto the succeeding pages, or a series or computer-generated images or hand-drawn sketches. In either case, when the pages 12′ are flipped in rapid succession, such as by holding the publication 10 with one hand and flipping through its pages 12 with the thumb of the other hand, as demonstrated in FIG. 2, the publication 10 conveys a visual impression of the runner 15 in motion.

In addition to the runner image 15, one or more of the image pages 12′ may also include a reference page identifier 16 intended to refer a user to a predetermined advertisement (or “reference”) page 20 of the publication. In one implementation, the reference page identifier 16 is a certain page number located proximate the runner image 15 and provided on each of the succeeding pages 12′ used to create the animated visual impression, such that when the pages 12′ are rapidly flipped both the animated runner image 15 and the reference page identifier 16 are readily and simultaneously discernable by the user. The flip page animation captures the interest and attention of the user, and directs the user to the specified reference page 20 of the publication 10. The reference page identifier 16 may be provided in the exact location on each of the image pages 12′.

In the exemplary embodiment, the pictorial representations 15 are located in respective margins or corners of the image pages 12′. Each image 15 may occupy less than 10% of a surface area defined by a single side of the image page 12′. The publication 10 may include a total of at least 50 bound and overlying paper pages 12. Of these pages 12, at least 50% may be image pages 12′—i.e., pages including the pictorial representations 15. Alternatively, greater than 75% of a total number of pages 12 included in the publication 10 may comprise image pages 12′.

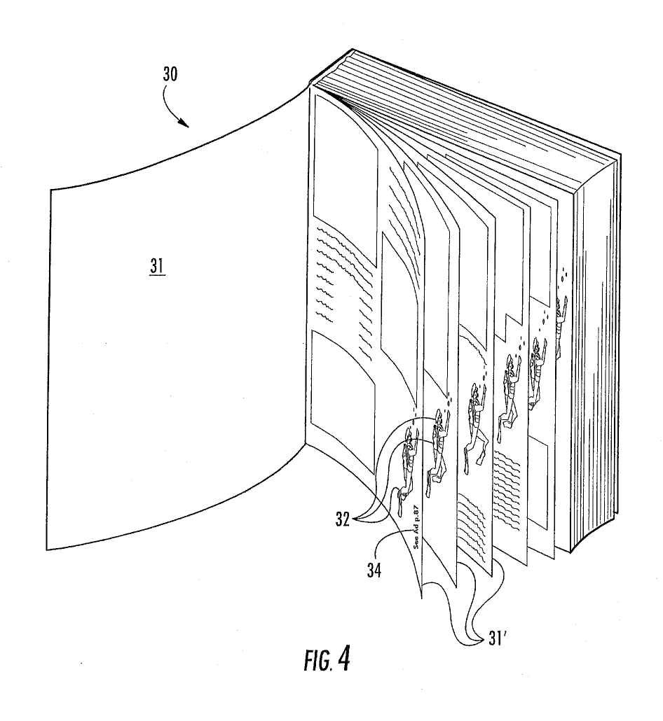

Referring to FIGS. 2 and 3, after viewing the flip-page runner animation 15, described above, the user notes the reference page identifier 16 and then turns to the indicated reference page 20 of the publication 10. A portion of the exemplary reference page 20 is illustrated in FIG. 3. As shown, the reference page 20 includes an advertising display 11′ comprising product information relating to the runner images 15—specifically, running shoes. The product information may include anything relevant to the advertised product, such as (but not limited to) the shoe brand 21, price 22, style 23, color 24, construction 25, photograph 26 or other image, and a descriptive overview 27.

A further exemplary embodiment of a publication 30 according to the present invention is illustrated in FIG. 4. Like that previously described, the publication 30 comprises a bound arrangement of overlying, sequentially numbered, paper pages 31 including a series of pictorial representations 32 provided on certain successive pages 31′. In this embodiment, a SCUBA diver image 32 is provided in the side margins of successive pages 31′ at different progressive positions, and appears to float from a bottom of the publication 30 towards a top of the publication 30 as the pages 31′ are flipped in rapid succession. A page reference indicator 34 may be provided on a single page 31, 31′ of the publication 30 to direct a user to an advertising display (such as described above) where additional information is offered. In this example, the advertising display may be for SCUBA diving lessons, equipment, or the like.

Exemplary embodiments of the present invention are described above. No element, act, or instruction used in this description should be construed as important, necessary, critical, or essential to the invention unless explicitly described as such. Although only a view of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under §112, 6th paragraph is not intended. Additionally, it is not intended that the scope of patent protection afforded the present invention be defined by reading into any claim a limitation found herein that does not explicitly appear in the claim itself.

I claim:

1. A publication, comprising:
a bound arrangement of overlying paper pages;
a series of pictorial representations comprising video frames digitally captured and reproduced individually on successive ones of said pages, wherein succeeding pages represent an object in different progressive positions, such that flipping said pages in rapid succession conveys a visual impression of the object in motion;
a display of advertising provided on a reference page of said publication, and comprising information relating to the object; and
a reference page identifier proximate the object and directing a user of said publication to said advertising display provided on said reference page.

2. A publication according to claim 1, wherein said reference page identifier comprises a page number located on each of said pages representing the object in different progressive positions.

3. A publication according to claim 1, wherein said pages are substantially superimposed and bound together adjacent a common margin.

4. A publication according to claim 1, wherein said pictorial representations are located in respective margins of said pages.

5. A publication according to claim 1, wherein said pictorial representations are located in respective corners of said pages.

6. A publication according to claim 1, wherein each pictorial representation occupies less than 10% of a surface area defined by a single side of said page.

7. A publication according to claim 1, and comprising at least 50 bound and overlying paper pages.

8. A publication according to claim 1, wherein said pictorial representations appear on at least 50% of a total number of pages included in said publication.

9. A publication according to claim 1, wherein said pictorial representations appear on greater than 75% of a total number of pages included in said publication.

10. A publication according to claim 1, wherein said advertising display provided on said reference page comprises a display object of a type depicted in said pictorial representations.

11. A publication according to claim 10, wherein said advertising display provided on said reference page further comprises pricing information for the display object.

12. A publication, comprising:
a bound arrangement of overlying paper pages, each page having a margin adjacent an unattached edge;
a series of pictorial representations comprising video frames digitally captured and reproduced individually in the margins of successive ones of said pages, wherein succeeding pages represent an object in different progressive positions and at different locations in the margins, such that flipping said pages in rapid succession conveys a visual impression of the object moving from one end of the page margins towards an opposite end of the page margins; and
a display of advertising provided on a reference page of said publication, and comprising information relating to the object.

13. A publication according to claim 12, and comprising a reference page identifier proximate the object and directing a user of said publication to said advertising display provided on said reference page.

14. A publication according to claim 13, wherein said advertising display provided on said reference page comprises a display object of a type depicted in said pictorial representations.

15. A publication according to claim 14, wherein said advertising display provided on said reference page further comprises pricing information for the display object.

16. A publication according to claim 12, wherein each pictorial representation occupies less than 10% of a surface area defined by a single side of said page.

17. A publication according to claim 12, and comprising at least 50 bound and overlying paper pages.

18. A publication according to claim 12, wherein said pictorial representations appear on at least 50% of a total number of pages included in said publication.

19. A publication according to claim 12, wherein said pictorial representations appear on greater than 75% of a total number of pages included in said publication.

20. A method for advertising in a publication comprising a bound arrangement of overlying paper pages, said method comprising:
providing a series of pictorial representations comprising video frames digitally captured and reproduced individually on successive pages of the publication, wherein succeeding pages represent an object in different progressive positions, such that flipping the pages in rapid succession conveys a visual impression of the object in motion;
providing an advertising display related to the object on a reference page of the publication; and
directing a user of the publication to the reference page to view the advertising display.
